(19) United States
(12) Patent Application Publication
(10) Pub. No.: US 2006/0070470 A1
(43) Pub. Date: Apr. 6, 2006

(54) Drive mechanism

(75) Inventors: Shane Robert McGill, Addington (GB); Martin White, Addington (GB)

Correspondence Address: NIXON & VANDERHYE, PC, 901 NORTH GLEBE ROAD, 11TH FLOOR, ARLINGTON, VA, 22203, US

(73) Assignee: MCGILL TECHNOLOGY LIMITED, Addington (GB)

(21) Appl. No.: 10/522,183

(22) PCT Filed: Jul. 15, 2003
(86) PCT No.: PCT/GB03/03079

§ 371 Date: Jan. 24, 2005

(30) Foreign Application Priority Data
Jul. 24, 2002 (GB) 0217235.1
Mar. 21, 2003 (GB) 0306597.6

(51) Int. Cl. F16H 1/12

(52) U.S. Cl. 74/416

(57) ABSTRACT

The invention is particularly concerned with providing a drive mechanism to extrude product from containers. In order to reduce the amount of effort which manual operation would entail there is provided a gear wheel 23 meshing with the driven gear through high ratio gearing, the driven gear 25 being associated with a cam 27 about which is located a cam follower 32. The cam follower carries a plunger arranged to move to engage the container 10 and discharge product therefrom.

This invention relates to drive mechanisms and, in particular, to mechanisms by which a drive member is moved reciprocally to effect discharge of the contents of a container.

Various mechanisms are available whereby a plunger is driveable reciprocally to discharge the contents of a container but such mechanisms are usually power driven so that even when discharge requires high forces, it is possible to provide sufficient force for discharge to take place. When, however, it is required to drive the plunger manually it can be difficult to achieve this when the required discharge force is high.

An object of the invention is to provide a drive mechanism which is operable manually and can provide sufficient discharge force for the purpose required.

According to the invention, a drive mechanism comprises a rotary member carrying a first gear wheel, a driven gear wheel meshing with the first gear wheel, the first gear wheel and the driven gear wheel having a high gear ratio whereby the driven gear wheel rotates more slowly than the first gear wheel, a cam mounted for rotation with the driven gear wheel, a cam follower engaging with the cam and moveable reciprocally upon rotation of the cam, the cam follower carrying a plunger arranged to be moveable therewith to engage a container of product and extrude product from the container.

Preferably, the first gear wheel is rotatable by a manually operated handle, but the wheel may be power driven, for example, by an electric motor.

Conveniently, spring means is provided to urge the cam follower into engagement with the cam, the cam operating to overcome the bias of the spring means during an operational movement of the plunger in one direction, and the spring means urging the cam follower in the opposite direction during a return movement of the plunger.

The cam may include at least one cam surface which in the circumferential direction progressively increases in its spacing from the rotational axis on the cam.

There may be provided two cam surfaces symmetrically arranged around the cam axis, there being two cam locations of the cam surfaces which lie closest to the axis of rotation, and two cam locations which lie furthest from the axis of rotation. The closest and furthest cam locations lying adjacent to one another, and the closest and furthest cam locations corresponding to a return and an operative plunger location respectively.

Alternatively there is one surface extending through 360° about the axis of the gear wheel.

The cam follower comprises a roller which engages with an outwardly directed cam surface. The roller may be urged into engagement with the cam by a gas spring.

Conveniently, the container is selectively locatable in alignment with the plunger movement in a discharge position, thereby to be engaged by the plunger in an operative movement thereof, the container being moveable to a non discharge, replacement position after discharge.

Conveniently, movement of the container between the discharge position and the replacement position is a sliding movement, the container being supported on a frame shaped to receive a container. The container may be carried on a pivotable support.

The container may include an outlet smaller in cross-section than that of the container for the discharge of product from the container, and the container has a portion arranged to be engaged and deformed or moved by the plunger to reduce the container volume and cause product to be extruded through said outlet. The portion may be deformable by inversion or in the nature of a piston inside a tubular container.

Further features of the invention may appear from the following description of an embodiment of an invention given by way of example and with reference to the drawings, in which,

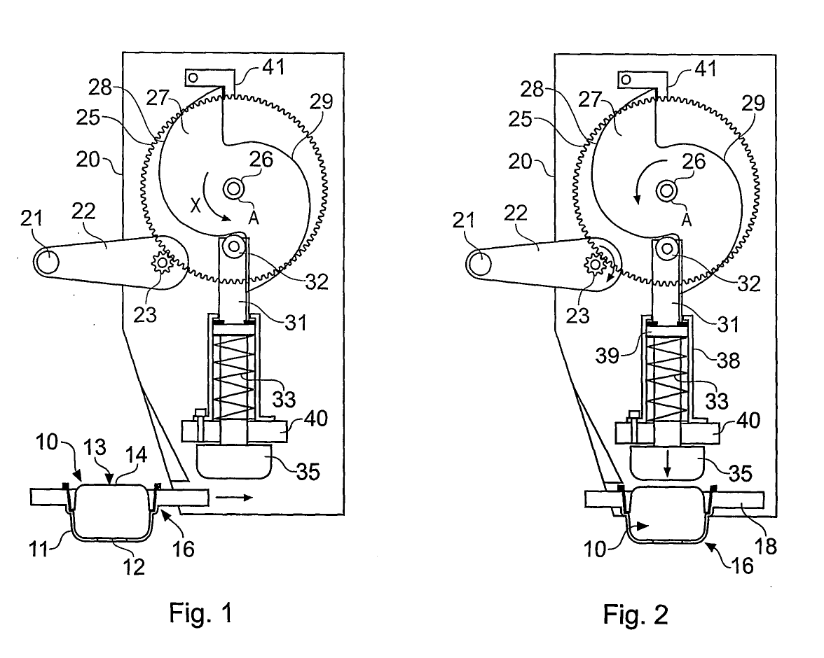

FIG. 1 is a schematic vertical section through a drive mechanism for dispensing product, in a first, loading position,

FIG. 2 is a view corresponding to FIG. 1 in a second, ready to dispense, position,

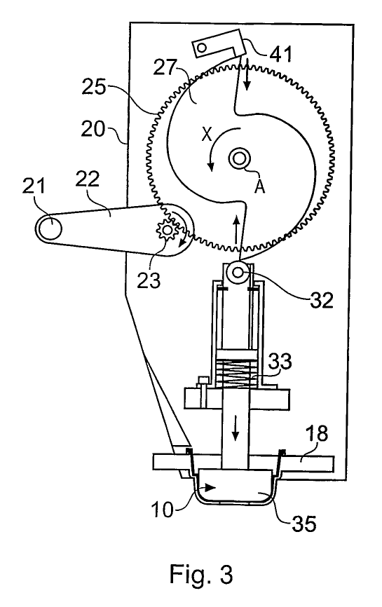

FIG. 3 is a view corresponding to FIGS. 1 and 2 in a third, dispensed position,

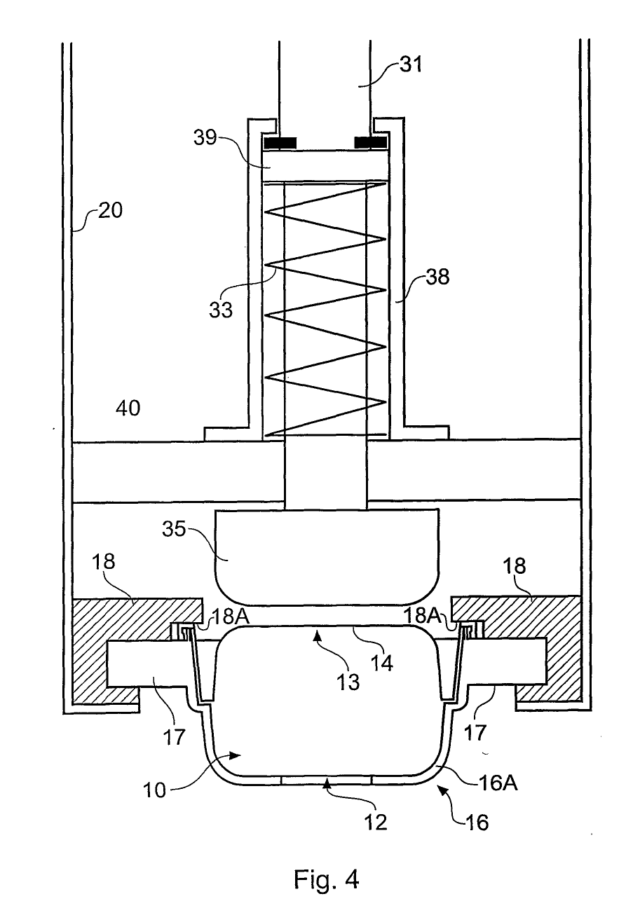

FIG. 4 is an enlarged cross section of the container location arrangement,

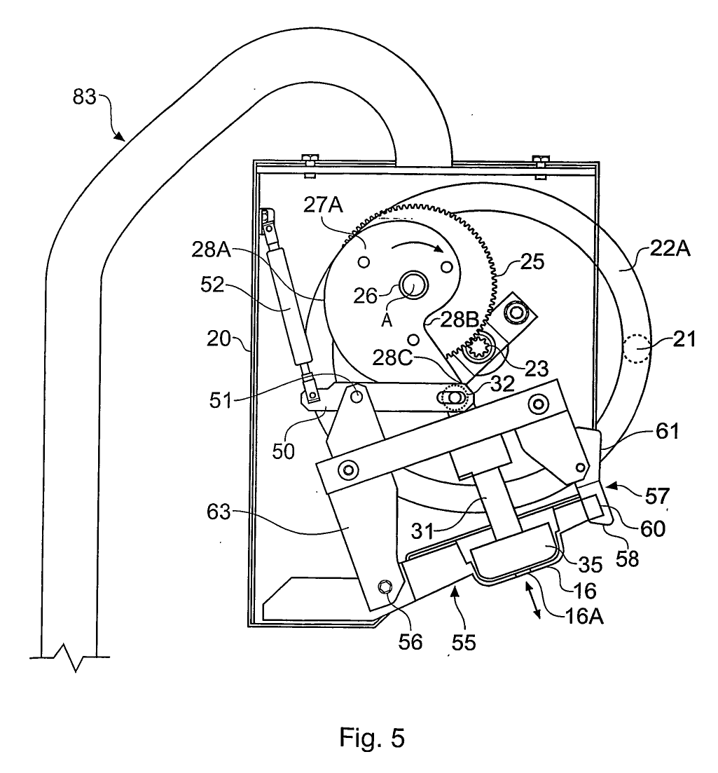

FIG. 5 is a sectioned side elevation of an alternative drive mechanism for dispensing product, in one position,

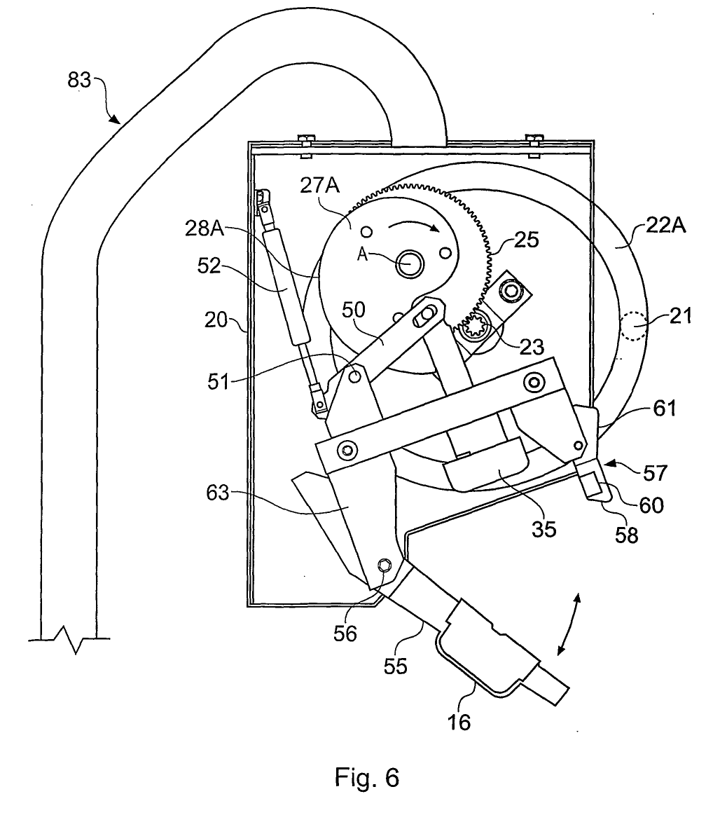

FIG. 6 is a view corresponding to FIG. 5 in another position,

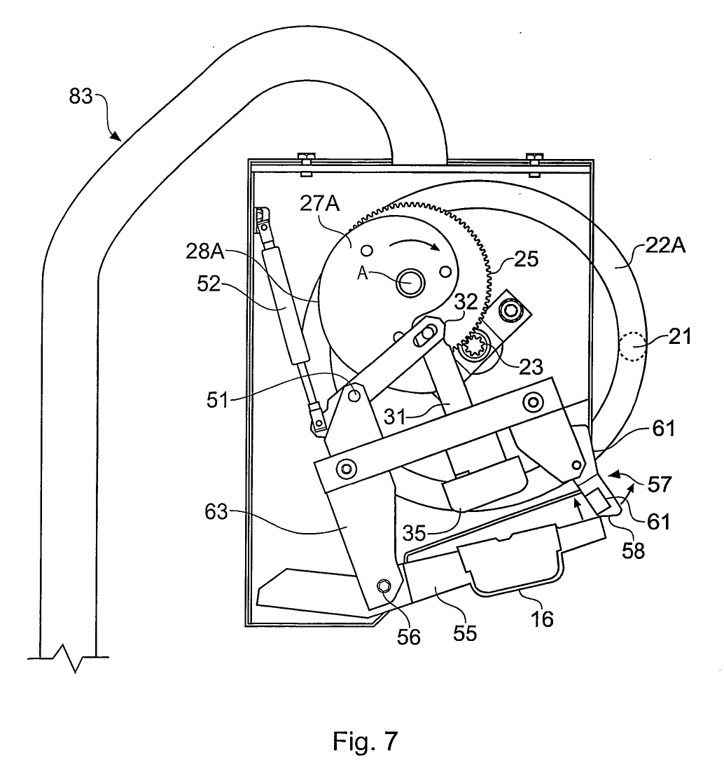

FIG. 7 is a view corresponding to FIGS. 5 and 6 in a further position,

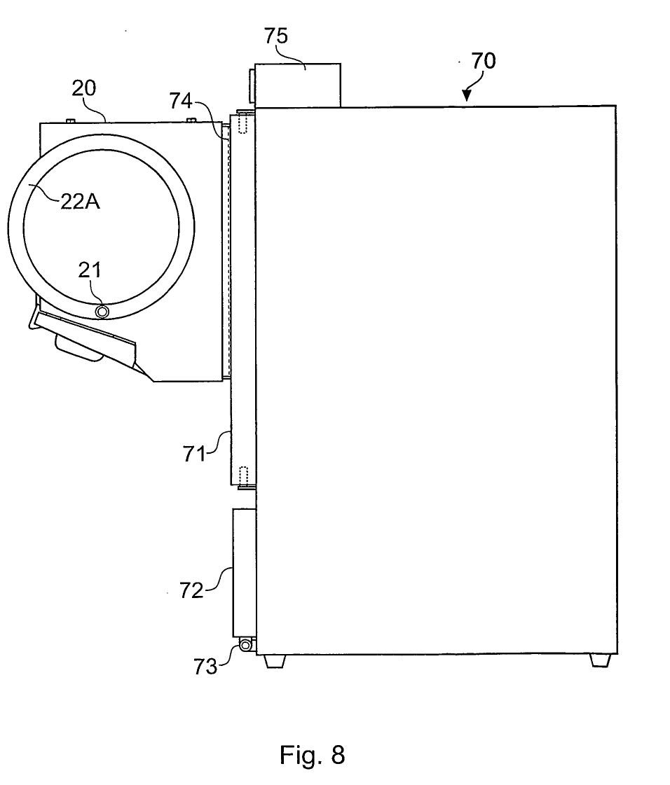

FIG. 8 shows in side view a mounting arrangement for the apparatus of FIGS. 5-7.

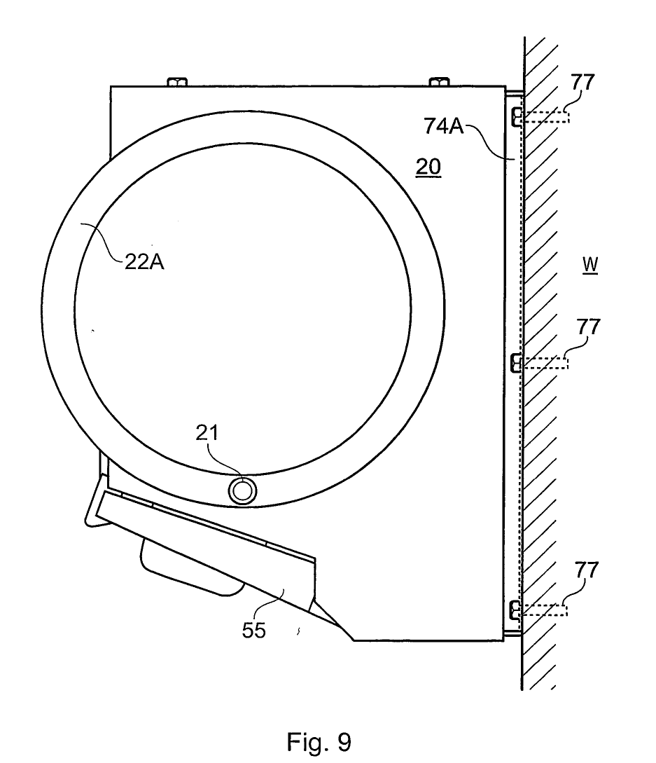

FIG. 9 shows an alternative mounting arrangement,

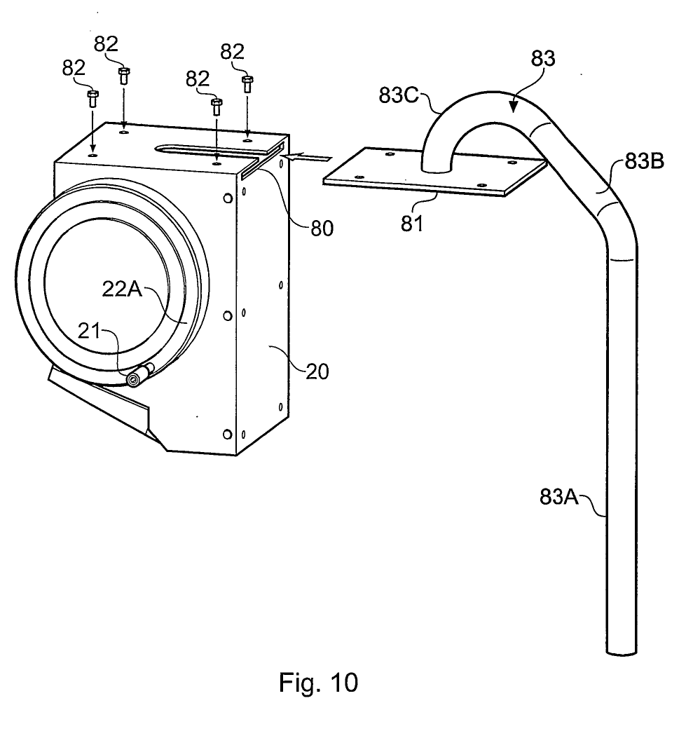

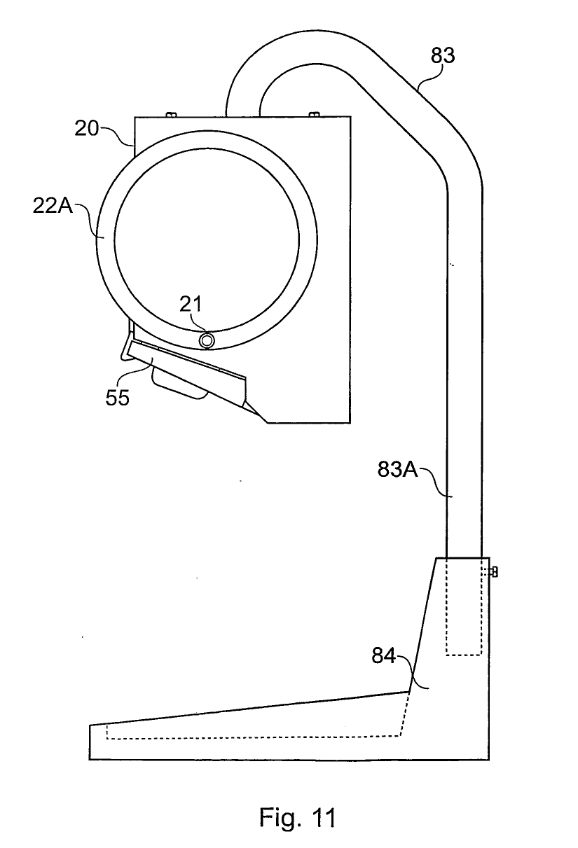

FIGS. 10 and 11 show a still further mounting arrangement,

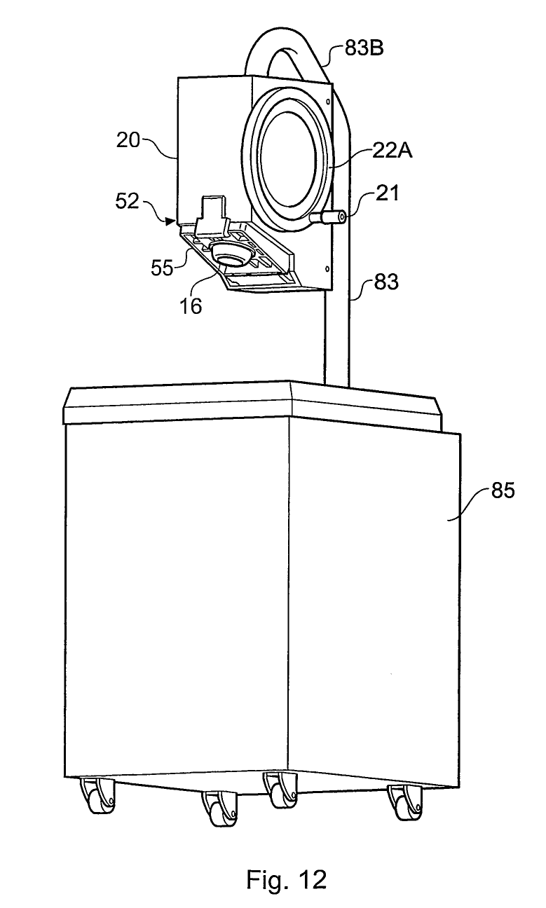

FIG. 12 shows a perspective view of an assembly corresponding to the arrangement of FIGS. 10 and 11.

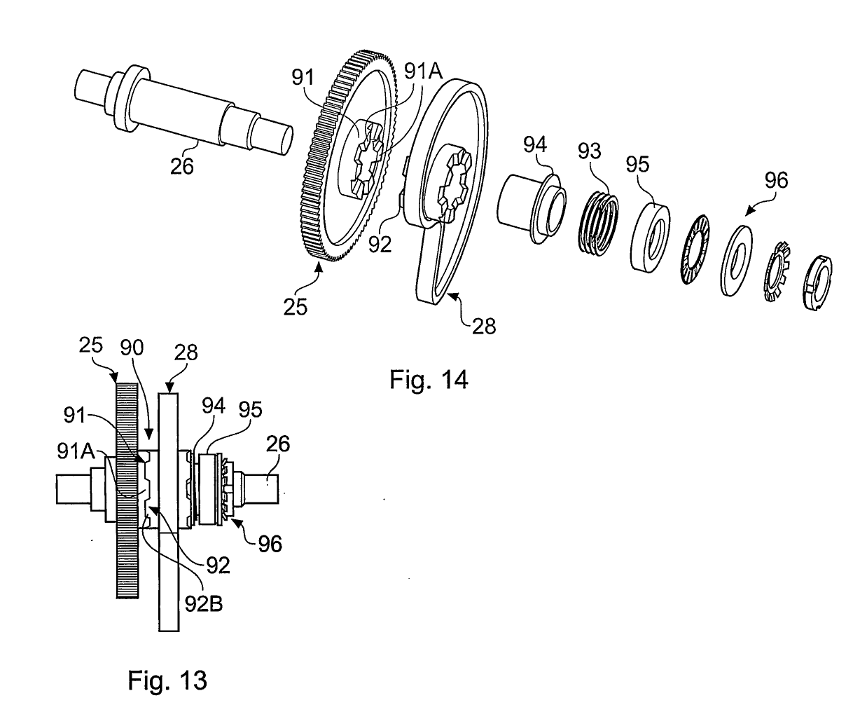

FIG. 13 is a side elevation of part of a modified drive, and

FIG. 14 is an exploded view of the arrangement of FIG. 13.

Referring to the drawings, and firstly to FIGS. 1-4, there is shown a drive mechanism which is suited to discharging containers of semi-solid product by an extrusion action. In the illustrated arrangement the container 10 is of known form and is for dispensing semi-solid food product, such as ice cream. It consists of a base part 11 in which is formed an outlet 12, and a closure member 13 located on the base part 11 and having a central, deformable portion 14 which can be deformed downwards into the base part to reduce the internal volume of the container and to cause product in the container to be extruded from the outlet 12.

The container 10 is generally circular in cross-section and the closure 13 is locatable on the base around the upper rim thereof to seal the container contents after filling and during transit. Instead of circular the container may have other curvilinear shapes such as rectangular with rounded corners.

The container outlet 13 is shaped to shape product being extruded therethrough and usually includes a seal, not shown, located over the outlet, except when discharge of the product from the container is to take place. The outlet may be of the form described in PCT/GB02/03340.

The deformable part 14 of the container deforms downwards towards contact with the inner surface of the base, thereby to empty the container.

The container is locatable in a sliding support member 16 which is moveable between a dispensing position, FIGS. 2, 3 and 4 and a non-operative recharging position, FIG. 1.

The container support 16 supports the base 11 of the container 10 and the support has an opening coinciding with the opening 12 in the container whereby product can be discharged downwards through the opening in the support.

The support 16 includes longitudinal side members 17 which are slideably mounted in guides 18 to enable the support to move horizontally between the discharge (FIGS. 2 and 3) and replacement (FIG. 1) positions. The support 16 is located at the lower end of a frame 20 in which the main drive mechanism is located.

The support 16 defines a seating 16A for containers and laterally extending portions 17 of the support engage in the guides 18, there being downwardly extending portions 18A of the guides which engage with upper edges of the container to secure the container in the seating and keep the closure on the base of the container.

The drive mechanism includes a rotatable handle 21 mounted on a lever arm 22 which is in turn journaled onto the frame 20.

The handle 21 and cam 22 are rotatable through 360° about a support mounted on the frame of the mechanism. The arm 22 carrying the handle 21 at one end, carries a first gearwheel 23 at the other end, the gearwheel 23 being of relatively small diameter and carrying a plurality of teeth around its periphery.

In meshing engagement with the first gearwheel 23, is a driven gearwheel 25 of much larger diameter than the first gearwheel 23 and which is mounted for rotation in the housing 20 about a rotational axis A on a shaft 26.

Also mounted on the shaft 26 is a cam 27 having the illustrated cam shape. Two cam surfaces 28 and 29 of symmetrical shape are located around the axis of rotation A and it will be seen that each cam surface 28, 29 commences at a relatively small distance from the axis of rotation and the spacing of the surfaces increases in the circumferential direction.

The cam surfaces 28, 29 have a progressively increased spacing from the cam axis A of rotation and, at their greatest spacing from said axis, one cam surface lies adjacent the other cam surface at the smallest distance from the axis of rotation. The cam surfaces can be said to each have a convolute form. Engaging with the cam surfaces 28, 29 is a cam follower 31 having a roller 32 which contacts the cam surfaces as the cam 27 is rotated in direction X. The roller 32 is urged into engagement with the cam surfaces 28, 29 in an upwards direction, there being a spring 33 to achieve this.

Rotation of the cam 27 causes the cam follower 31 to move away from the axis A of rotation of the cam and this movement is against the action of the spring 33 which urges the follower into engagement with the cam surfaces 28, 29.

The cam follower 31 includes at its end opposite to the roller 32 a plunger head 35 which is moved to a discharge position in the downwards, discharge direction, FIG. 2, upon rotation of the cam 27. After reaching a full discharge position FIG. 3, the plunger head moves upwards on a plunger return movement under the action of the spring and by the cam follower moving to a location closest to the cam axis, FIG. 4.

It will be seen that the arrangements provide means for reciprocally moving the plunger head 35 up and down in a generally vertical direction so that a container 10 of product on the support 16 is engageable with the plunger. Rotation of the cam causes the plunger to move downwards, to deform the container and extrude product from the container outlet.

In FIG. 3, the plunger has completed a container discharge operation and the cam follower 31 is about to be urged by the spring 33 into a position in which the spring is fully extended and the cam roller 32 is located on the surface 28 or 29 at its closest position to the axis of rotation A of the cam 27. The empty container is then displaced away from a discharge position for removing an empty container and locating a fresh container in the support, FIG. 1. A fresh container on the support 16 is then slid back under the plunger head 35 for a further discharge operation to take place.

The plunger head 35 is shaped having regard to the shape of the container 10 to be discharged and the follower 31 acts as a shaft on which the head 35 is mounted. The shaft 31 extends through a support 40 and a cylindrical tube 38 in which the spring 33 is located and carries a collar 39 which is engaged by the upper end of the spring. Movement of the collar 39, and hence the shaft 31, upwards is constrained by the upper end of the tube 38.

A pivoted latch 41 is arranged to engage the outer edge of the cam 27 and to prevent the cam from rotating in the wrong direction. In addition the rotation of the cam will be arranged to activate an audible signal to the user that discharge of a container is complete.

Referring now to FIGS. 5-12, there is shown an alternative drive mechanism to that shown in the previous figures and an assembly in which the drive mechanism may be employed.

Similar parts have the same reference numbers in both embodiments.

A drive mechanism for causing a plunger 35 to move reciprocally and discharge the contents of product containers is intended for the same purpose as the previous embodiment.

Similar to the previous embodiment, there is provided cam operation of the plunger 35. In this case, the handle 21 is located on a disc member 22A which is rotatable about its central axis. Rotatable with the disc member 22A is a gear wheel 23 which is arranged to mesh with a larger gear wheel 25 rotatable about an axis A. The gear wheel 25 carries for rotation therewith a cam member 27A which defines a single cam surface 28A extending 360° about the axis A. The cam surface 28A has a radially inner most portion 28B and spacing of the cam surface 28A from the axis A progressively increases in the circumferential direction so that the maximum spacing from the axis lies at 28C.

Although the cam surface 28A is shown as having a convolute surface, the cam surface shape may be varied in the circumferential direction to give different movement to the plunger 35 according to the pressure required to discharge contents from the container. In some cases, the pressure required to discharge product from the container changes over the discharge cycle. A cam follower 32 is mounted at the opposite end to the plunger head 35 and intermediate the follower 32 and the head 35 is a shaft 31.

The follower 32 is mounted on the end of a lever 50 which is pivoted at 51 and the end of the lever 50 remote from the follower 32 is pivotally connected to a gas spring 52, the other end of gas spring 52 being secured to the casing 20. The gas spring 52 is arranged to urge the follower into engagement with the cam surface 28 but as the cam follower 32 progresses beyond the portion of the cam surface 28C to the portion of the cam surface 28B, the gas spring, in urging the follower 32 radially inwardly, causes such movement to be controlled and not a sudden movement.

It will be seen that as the disc 22A is turned by the handle 21 in a clockwise direction, as seen in FIG. 5, the plunger head 35 is caused to move reciprocally into engagement with a container to be discharged. Due to the mechanical advantage of the gear arrangement 23 and 25, the effort required to discharge the contents of the container is within the operator's manual abilities.

The container is located in a seating 16 shaped according to the shape of the underside of the container and having a central opening coinciding with the opening in the container through which discharge is achieved. The seating 16 is formed on a pivotal arm 55, pivoted about axis 56 between an operative discharge position (FIG. 5) a release position (FIG. 7) and a recharging position (FIG. 6). In the operative position of FIG. 5, the arm 55 is latched into position using a latching mechanism 57 which is pivotable between the position of FIG. 5 and the position of FIG. 7. In latching into the position of FIG. 5, the outer end of the arm 55 engages an inclined end 58 of the latch 57 which pivots the latch against the constraint of spring means to admit the end of the arm into a latching groove 60. The latch 57 has a manually engageable portion 61 which may be depressed by the operator to pivot the latch 57 in an anticlockwise direction and release the arm 55 from the groove 58, after discharge of the container has taken place.

A frame member 63 supports the seating 16 and associated arm 55 in relation to the housing 20 to provide a rigid frame capable of acting as an abutment during operation of the plunger 35.

The sequence of operations of the drive mechanism includes locating a container in the seating 16 when the arm 55 is in the position shown in FIG. 6. The arm 55 is then manually raised into position so that the outer end of the arm latches into the groove 60 to secure the arm rigidly in position for a discharge operation.

Discharge of the container can then take place by rotating the disc 22A using the handle 21 in a direction to cause the cam 27A to rotate in a clockwise direction. At the commencement of a discharge operation the follower 32 is located on the cam surface 28B with the plunger fully retracted. During rotation, the plunger is moved downwards towards the seating 16 by engagement between the follower 32 and the cam surface 28A. Full extension of the plunger 35 and full discharge of the contents of the container are achieved when the follower 32 is engaged with the cam surface portion 28C. The plunger 35 will then be pressing directly against the base of the container to ensure that the contents are fully discharged. However, if desired, the container may be partially emptied at any stage in the discharge cycle and the container fully emptied at a separate time. Preferably the container is half emptied and, if required, the half empty container is relocated in a storage cabinet.

Upon fully discharging the container, continued rotation of the disc 22A causes the plunger 35 to move in a return direction as the follower 32 moves from surface 28C to surface 28B under the constraint of the gas spring 52 to ensure that the movement is smooth. The arm 55 can then be released by depression of the latch 57 so that the arm moves downwards, the container is released from the arm and a fresh container is located on the seating 16 which takes place with the arm 55 in the position shown in FIG. 6. Alternatively, the arm 55 is released automatically, the upward movement of the mechanism operating to release the latch 57.

The arm 55 is preferably arranged to be readily removable so that the arm and associated seating 16 can be easily cleaned when released from the machine. Moreover a different arm may be located having a different size seating 16 for different size containers.

In some cases, the container has a relatively small capacity of, say, 165 mm but there may be circumstances where a larger capacity container of, say, 300 mm is more suited and this simply achieved by having an arm to accommodate the large containers. In some cases, the plunger head 35 may be of the same dimensions with the larger containers but in other circumstances it may be appropriate to replace the head 35 with a different sized head to accommodate the different sized container.

As an alternative, to accommodate different size containers, the apparatus may have two dispensing heads 35 and two separate container locations, one for each size of container. Such an arrangement can retain the common elements of the gears and cam arrangement described. Alternatively, drive mechanisms may be provided for each plunger head and associated seating mounted on opposite sides of the housing, there being two drive systems, one for each head. In such arrangement left and right hand handles 21 are provided.

As mentioned, the embodiment of FIGS. 5-7 is arranged so that a constant revolutionary speed of the drive is utilised and this takes no account of the relative position of the plunger 35 where more or less dispensing force may be needed at different positions. In most cases, the energy required to dispense will change during the course of the dispensing operation. To accommodate such different force levels, the shape of the cam is changed so that a consistent force is applied to dispense the product whilst the drive handle is moved at a constant speed. Such an arrangement is applicable whether the container and the way it obtains its reduction in volume is as described, or is of another form such as a piston and cylinder arrangement.

Referring more particularly to FIGS. 8-12, there is shown various ways in which the drive mechanism for dispensing can be located in relation to associated equipment or mountings.

In the case of the arrangement of FIG. 8, the apparatus is mounted on the front of a refrigeration or freezer cabinet 70 for containing product in containers for dispensing by the apparatus. In this case, the cabinet 70 has a door 71 on its front side which is openable about a vertical axis to gain access to and to introduce containers of product into the upper part of the cabinet. The cabinet also has a lower door access 72 which is hinged about a lower horizontal axis 73 to gain access to containers to be taken from the cabinet 70 and placed in the apparatus for dispensing.

The apparatus is mounted on the door 71 and is supplied with a rear plate 74 fixed to the apparatus and having means for securing the plate 74 to the door 71. The plate 74 may be in the form of an L shaped bracket which extends up the rear of and over the top of the apparatus. The cabinet 70 has a control panel 75 on its upper side.

Alternatively, the apparatus is mounted on the side wall of a storage cabinet supported by a mounting on the top of the cabinet. The cabinet may be of the kind described in U.S. Pat. No. 5,749,240.

Referring now to FIG. 9, there is illustrated a wall mounted apparatus in which a plate 74A similar to that of FIG. 8 is attached to the rear side of the apparatus and is fixed to a wall W by fixing means 77 extending through the plate 74A into the wall. Again, the plate 74A may be an L shaped plate extending up the rear of the apparatus and over the top side.

Referring now to FIGS. 10 and 11, there is shown a support for the apparatus which may be mounted from the top. In this case, the top of the apparatus is formed with a slot 80 shaped to receive a plate 81 as a close fit, the plate 81 being held in the slot 80 by fixing screws 82.

The plate 81 is rigidly secured to a tube 83 which has a vertical portion 83A, a curved portion 83B and a downwardly directed portion 83C, the lower end of which is secured to the plate 81. By this arrangement the tube 83 can be mounted in any convenient way so that the apparatus can be located, for example, above a refrigeration unit with a saving of space.

In the FIG. 11 arrangement, the lower end of the tube 83 is mounted in a bracket 84 which supports the apparatus on a surface or is otherwise secured to a mounting.

The dispensing apparatus is readily removable from the support for replacement purposes or to effect repairs.

As a further alternative, the dispensing apparatus can be suspended on a support from a ceiling or wall. In each case the electricity supply and any other supply to the apparatus can be introduced through the mounting, if such supply is required.

FIG. 12 shows an assembly of dispensing apparatus, support tube 83 and floor mounted cabinet for locating refrigerated containers 85.

Instead of the dispensing apparatus described, similar mounting arrangements can be employed for other dispensing apparatus. In each case the housing is provided with means for locating the support to suspended, wall mount the apparatus, removably on its support.

Referring now to FIGS. 13 and 14, there is shown a drive arrangement applicable to any of the previously described embodiments. The force applied to turn the handle in normal use is arranged to be such that any one can operate the handle. The illustrated arrangement is for limiting the effective force which can be applied to the plunger 35 during operation. However, some limitation may be required when the operator is turning the handle 21 and the gear wheel 25 and there is excessive resistance to movement of the plunger 35, for example, when product in the container 10 is too hard to be extruded. Applying excessive force to the plunger in these circumstances may give rise to damage to the arm 55 and/or the container 10, or the gear wheel.

The arrangement of FIGS. 13 and 14 employs a clutch mechanism 90 for transmitting drive between the gear wheel 25 and the cam member 28. The mechanism 90 includes a component 91 mounted on but preferably integral with the gear wheel 25. The mechanism includes a complimentary clutch component 92 mounted on and integral with the cam member 28 and the various components may be of integral moulded plastics.

The components 91 and 92 are arranged to inter-engage and rotate together during normal operation but to be relatively rotatable when the torque to be transmitted exceeds a predetermined amount.

The cam member 28 is mounted for axial movement relative to the gear wheel 25 and is biased towards the gear wheel 25 by a spring 93 extending between a collar 94 movable on the shaft 26, with the member 28, and a cup member 95 fixed in relation to the shaft 26 by fixing means 96.

The components 91 and 92 inter-engage and are located for rotation with one another by a series of inter-engaging teeth 91A and 92A which have mutually inclined surfaces so that, should the torque to be transmitted exceed a certain amount, the teeth ride over one another and the cam member moves in the axial direction against the bias of the spring 93 away from the gear wheel 25, thereby preventing such further torque from being transmitted.

If this occurs the operator must check why the torque has become excessive and change the container to one having softer contents, or take whatever other action is required.

It will also be appreciated that the drive system described may be handed to be used either by the left hand or the right-hand of the operator. The cam member 28 has, as shown in FIGS. 13 and 14, teeth 92 on both sides to permit reversal.

A bell arrangement can also be employed to signify the completion of a dispensing operation.

This may consist of a conventional bicycle bell whose clapper, in moving slowly during dispensing does not strike the bell part. However, during rapid movement from the high to low cam profiles, the clapper rings the bell during rapid movement.

Although the apparatus is envisaged as being suited to dispensing apparatus for dispensing ice cream and other desserts, it can also be used for dispensing other food products such as the ingredients for milkshakes. In this case, the containers will contain the milkshake ingredients which are then dispensed into a milkshake container. The container is then fitted with a closure after water or other added material is introduced. Blending then takes place and a milkshake is produced.

The blending elements may be one which is accommodated in the closure or in the container so that blending is completed in the same vessel and the product can be consumed from that vessel after blending. In this arrangement, the blending elements are contained on the closure or in the container vessel and the blending elements are operated by a separate drive system. Such blending apparatus can be located adjacent the dispensing apparatus described. Similarly, the containers and their closures can be stored in storage arrangements mounted on or adjacent to the apparatus.

If water is added, the temperature of the water can be suited to the intended temperature of the milkshake product. Similarly, additional product such as foaming agent can be added prior to blending operation.

Any additive such as water can be initially at ambient temperature and can be cooled prior to use by a heat exchanger such as a chilling coil or tank.

It will be appreciated that although there is shown and described a cam and cam follower arrangement in which the cam is provided with a roller which engages with a cam surface, instead there could be provided a captive cam follower arrangement in which the follower is located between cam surfaces and in this case the spring may not be needed as the plunger will be retracted upwards after completing a discharge operation.

The invention described may find particular application in a dispensing machine such as described in WO 94/13154 (PCT/GB93/02572).

1. A drive mechanism comprising a rotary member carrying a first gear wheel, a driven gear wheel meshing with the first gear wheel, the first gear wheel and the driven gear wheel having a high gear ratio whereby the driven gear wheel rotates more slowly than the first gear wheel, a cam mounted for rotation with the driven gear wheel, a cam follower engaging with the cam and moveable reciprocally upon rotation of the cam, the cam follower carrying A plunger arranged to be moveable therewith to engage a container of product and extrude product from the container.

2. A drive mechanism according to claim 1 wherein the first gear wheel is rotatable by a manually operated handle.

3. A drive mechanism according to claim 1 wherein spring means is provided to urge the cam follower into engagement with the cam, the cam operating to overcome the bias of the spring means during an operational movement of the plunger in one direction, and the spring means urging the cam follower in the opposite direction during a return movement of the plunger.

4. A drive mechanism according to claim 1, wherein the cam includes at least one cam surface which, in the circumferential direction, progressively increases in its spacing from the rotational axis of the cam.

5. A drive mechanism according to claim 1, wherein there is provided two cam surfaces symmetrically arranged around the cam axis, there being two cam locations on the cam surfaces which lay closest to the axis of rotation and two cam locations which lay furthest from the axis of rotation. The closest and furthest cam locations lying adjacent to one another and the closest of the further cam locations corresponding to a return and an operative plunger location respectively.

6. A drive mechanism according to claim 1, wherein there is one cam surface extending through substantially 360 degrees about the axis of the associated gear wheel.

7. A drive mechanism according to claim 1, wherein the cam follower comprises a roller which engages with an outwardly directed cam surface.

8. A drive mechanism according to claim 1, wherein the container is selectively locatable below the mechanism, in alignment with the plunger movement in a discharge direction, thereby to be engaged by the plunger in an operative movement thereof, the container being moveable to a non discharge, replacement position after discharge.

9. A drive mechanism according to claim 1 wherein movement of the container between a discharge position and a replacement position is a sliding movement, the container being supported on a frame shaped to receive the container.

10. A discharge mechanism according to claim 1 wherein the container includes an outlet smaller in cross section than that of the container through which outlet product is discharged, the container having a portion arranged to be engaged, deformed or moved by the plunger to reduce the container volume and cause product to be extruded through said outlet.

11. A discharge mechanism according to claim 1 comprising clutch means located between the driven gear wheel and the cam whereby, when the drive force necessary for the gear wheel to drive the cam exceeds a predetermined amount, the clutch is operated to disengage drive.

12. A drive mechanism according to claim 11, wherein the clutch mechanism includes inter engaging teeth of which the flanks of the teeth are inclined and the driven gear wheel and the cam are relatively axially moveable whereby when the gear teeth override one another, drive is discontinued to the cam.

13. A container discharge mechanism for discharging the semi-solid contents of a container, comprising a rotary member carrying a first gear wheel, a driven gear wheel meshing with the first gear wheel, the first gear wheel and the driven gear wheel having a high gear ratio whereby the driven gear wheel rotates more slowly than the first gear wheel, a cam mounted for rotation with the driven gear wheel, a cam follower engaging with the cam and moveable reciprocally upon rotation of the cam, and a plunger arranged to be moveable with the cam follower to engage a container of product and extrude product from the container outlet.

14. A mechanism according to claim 13, wherein the container has a portion moveable relative to the container to reduce its internal volume so that, upon operation of the plunger, product is discharged therefrom through a container outlet.
